(19) United States
(12) Patent Application Publication
(10) Pub. No.: US 2026/0345440 A1
(43) Pub. Date: Nov. 5, 2026

(54) VIAL ADAPTER FOR CLOSURE SYSTEMS

(71) Applicant: WEST PHARMACEUTICAL SERVICES, INC., Exton, PA (US)

(72) Inventor: Anthony J. WIRTEL, III, Malvern, PA (US)

(21) Appl. No.: 19/120,210

(22) PCT Filed: Oct. 6, 2023
(86) PCT No.: PCT/US2023/076182

§ 371 Date: Apr. 10, 2025

Related U.S. Application Data
(60) Provisional application No. 63/416,406, filed on Oct. 14, 2022.

(51) Int. Cl. A61J 1/20

(52) U.S. Cl. CPC A61J 1/2096; A61J 1/201; A61J 1/2055

(57) ABSTRACT

A vial adapter for a closure system having an elastomeric stopper and a cap is provided. The vial adapter includes a top wall, a connector extending therefrom in a first direction, and a cannula extending from the top wall in a second direction. The cannula includes a sharp distal tip for piercing the elastomeric stopper and providing for fluid communication between the vial adapter and the vial when the vial adapter is mounted to the vial. A skirt extends from the top wall and surrounds the cannula. The skirt includes at least one flexible retention arm having a retention latch for snap fitting to an underside portion of the cap of the closure system when the vial adapter is mounted to the vial. The cannula has a length from the top wall such that the sharp distal tip of the cannula is located proximal to the retention latch.

### CROSS REFERENCE TO RELATED APPLICATIONS

This application is a US. National Stage of International Patent Application No. PCT/US2023/076182, filed Oct. 6, 2023, which claims the benefit of U.S. Provisional Patent App. No. 63/416,406, filed Oct. 14, 2022, the disclosures of which are hereby incorporated by reference herein in their entireties.

### FIELD OF THE INVENTION

The present disclosure generally relates to a drug transfer device for use in mixing medicinal substances, and more particularly, to a vial adapter configured to facilitate attachment onto a closure system of a medicine vial.

### BACKGROUND

Many types of drugs are commonly packaged in glass vials to provide a convenient and safe way to transport and store the drugs. A standard drug vial is typically closed by an elastomeric stopper which seals an opening of the vial. A metal closure, such as a metal crimp ring, is then installed over the elastomeric stopper to ensure the elastomeric stopper remains secured to the vial. This is accomplished by folding a bottom end of the metal crimp ring under an overhang portion extending from the vial neck for securing the crimp ring to the vial. An edge of the folded portion of the crimp ring is typically rounded so as to conform to the shape of the overhang portion of the vial. Conventional crimp rings are usually made from aluminum due to its malleability, thus facilitating installation on the vials. Moreover, conventional metal crimp rings typically include an opening through which the elastomeric stopper is accessible without requiring a user to remove the crimp ring from the vial. A protective cap can also be snap fitted over the crimp ring to cover the opening in the crimp ring for maintaining sterility of the elastomeric stopper underneath. A desired amount of drug product is able to be removed from the vial at the time of use by removing the protective cap and then penetrating the elastomeric stopper with a piercing member, such as a syringe needle or a vial adapter cannula, thus allowing a user to access the contents of the vial.

The use of a vial adapter to access contents of a vial is often considered preferable over the use of a syringe needle from a safety standpoint, since conventional vial adapters eliminate the use of needles, and therefore the risk of needle stick injuries is minimized. Furthermore, the use of a vial adapter allows more precise location of the point where liquid is extracted from the vial, potentially reducing the amount of unremovable residual drug left in the vial.

Conventional vial adapters require application of a large amount of force to assemble onto standard vial having a metal closure system. These large assembly forces have been shown to lead to repetitive stress injuries, especially when the assembly takes place in a safety cabinet. Such large forces are due in part to the need to accommodate a wide range of metal crimp ring and vial geometries. Moreover, gripping forces are increased in order to retain a conventional vial adapter on the vial and prevent accidental disassembly since typical metal crimp rings do not provide an ideal seating surface for the vial adapter. Additionally, where drug products are potentially toxic (e.g., chemotherapy drugs), the clamping forces of the metal crimp ring onto a vial are further increased in an effort to improve reliability. While a conventional closed system transfer device (CSTD) would be desired to maintain sterility in this situation, not all CSTDs are compatible with all vials. In some cases, it can be more likely for a user to accidently disassemble the CSTD due to incompatibility with the vial, thus resulting in the potential for exposure of the user to a hazardous drug product.

As a result, plastic closure systems are becoming increasingly desired over their counterpart metal closure systems for a variety of reasons. For instance, manufacturers seeking to rapidly change formats in a flexifiller can be challenged by a variety of issues, including availability of nested closures or aluminum particulate from seals. However, conventional vial adapters are not compatible with plastic closure systems. There is therefore a clear and substantial need for a vial adapter that is compatible with plastic closure systems, including existing plastic closure systems. Further, there is a need to provide a vial adapter that does not require large assembly forces for securing to plastic closure systems. Similarly, there is a need to provide a vial adapter that provides increased gripping forces to plastic closure systems.

### SUMMARY

The foregoing needs are met by the vial adapter of the present disclosure. According to one aspect of the present disclosure, the vial adapter comprises a top wall configured to cover a top portion of the closure system when the vial adapter is mounted to the vial; a connector extending from the top wall in a first direction, the connector configured to connect to a drug transfer device; a cannula extending from the top wall in a second direction, the cannula including a sharp distal tip operable to pierce the elastomeric stopper of the closure system and to provide for fluid communication between the vial adapter and the vial when the vial adapter is mounted to the vial; and a skirt extending from the top wall and surrounding the cannula, the skirt defining an opening configured to at least partially receive the closure system, the skirt including at least one flexible retention arm having a retention latch configured to snap fit to an underside portion of the cap of the closure system when the vial adapter is mounted to the vial, wherein the cannula has a length from the top wall such that the sharp distal tip of the cannula is located proximal to the retention latch.

According to another aspect of the present disclosure, the flexible retention arm further comprises a locking tongue protruding into the opening defined by the skirt, the locking tongue configured to correspondingly snap fit into an annular recess formed along a circumferential perimeter of the cap of the closure system when the retention latch snap fits to the underside portion of the cap.

According to another aspect of the present disclosure, the retention latch is a pawl having a leading face configured to facilitate attachment of the skirt over the top portion of the closure system, and a trailing face configured to lock the skirt to the underside portion of the closure system.

According to another aspect of the present disclosure, an elastomeric band surrounds the skirt and is operable to resist the flexible retention arm from deflecting away from the longitudinal axis of the vial adapter.

According to another aspect of the present disclosure, the elastomeric band is a rubber ring.

According to another aspect of the present disclosure, an outer surface of the skirt includes a lip protruding away from the longitudinal axis of the vial adapter, the lip configured to prevent the elastomeric band from sliding off the skirt when the flexible retention arm is not deflected.

According to another aspect of the present disclosure, the skirt includes a plurality of flexible retention arms.

According to another aspect of the present disclosure, the skirt further comprises at least one slit that separates adjacent flexible retention arms.

According to another aspect of the present disclosure, the skirt further comprises at least one connection bridge disposed within a corresponding at least one slit and interconnecting adjacent flexible retention arms.

According to another aspect of the present disclosure, the skirt further comprises an outer surface having an annular groove configured to provide controlled flexing of each flexible retention arm.

According to another aspect of the present disclosure, the annular groove forms a corresponding section of decreased thickness in each flexible retention arm.

According to another aspect of the present disclosure, each flexible retention arm further includes a first flexible finger and a second flexible finger.

According to another aspect of the present disclosure, the first and second flexible fingers of each flexible retention arm are separated by a cutout portion.

According to another aspect of the present disclosure, the cannula extends along a longitudinal axis of the vial adapter perpendicular to the top wall.

According to another aspect of the present disclosure, the first direction of the connector extending from the top wall is opposite from the second direction of the cannula extending from the top wall.

According to another aspect of the present disclosure, the connector extends along a longitudinal axis of the vial adapter substantially perpendicular to the top wall.

According to another aspect of the present disclosure, the connector is a Luer connector.

According to another aspect of the present disclosure, a method of using a vial adapter to access contents of a vial sealed by a closure system having an elastomeric stopper and a cap is provided. The method comprises aligning the vial adapter to be substantially concentric with the closure system; pushing the vial adapter over the closure system such that the at least one flexible retention arm deflects away from a longitudinal axis of the vial adapter as the cap is received within an opening of the skirt and until the retention latch snap fits to an underside portion of the cap; and connecting a drug transfer device to the connector of the vial adapter to establish fluid communication between the vial and the drug transfer device.

According to another aspect of the present disclosure, a sharp distal tip of the cannula pierces the elastomeric stopper of the closure system after the at least one flexible retention arm is deflected away from the longitudinal axis of the vial adapter and before the retention latch snap fits to the underside portion of the cap of the closure system.

According to another aspect of the present disclosure, the retention latch is a pawl having a leading face configured to facilitate attachment of the skirt over a top portion of the closure system, and a trailing face configured to lock the skirt to the underside portion of the closure system.

There has thus been outlined certain embodiments of the present disclosure in order that the detailed description thereof herein may be better understood, and in order that the present contribution to the art may be better appreciated. There are additional embodiments of the present disclosure that will be described below and which form the subject matter of the claims appended hereto.

In this respect, before explaining at least one aspect of the present disclosure in detail, it is to be understood that the vial adapters discussed herein are not limited in their application to the details of construction and to the arrangements of the components set forth in the following description or illustrated in the drawings. The vial adapters are capable of aspects in addition to those described, and of being practiced and carried out in various ways.

### BRIEF DESCRIPTION OF THE DRAWINGS

In order that the present disclosure may be readily understood, aspects of the vial adapter are illustrated by way of examples in the accompanying drawings, in which like parts are referred to with like reference numerals throughout.

FIG. 1 illustrates a top perspective view of a vial adapter according to the present disclosure.

FIG. 2 illustrates a bottom perspective view of the vial adapter of FIG. 1 without an elastomeric band.

FIG. 3 illustrates a cross-sectional side view of the vial adapter of FIG. 1.

FIG. 4 illustrates a perspective cross-sectional view of the vial adapter of FIG. 1 without the elastomeric band.

FIG. 5 illustrates a cross-sectional side view of the vial adapter of FIG. 1 in alignment with a syringe.

FIG. 6 illustrates a side view of the vial adapter of FIG. 1 in connected to a syringe and a vial.

FIG. 7 illustrates a top perspective view of a vial adapter according to another implementation of the present disclosure.

FIG. 8 illustrates a bottom perspective view of the vial adapter of FIG. 7.

FIG. 9 illustrates a cross-sectional side view of the vial adapter of FIG. 7.

FIG. 10 illustrates a perspective cross-sectional view of the vial adapter of FIG. 7.

### DETAILED DESCRIPTION

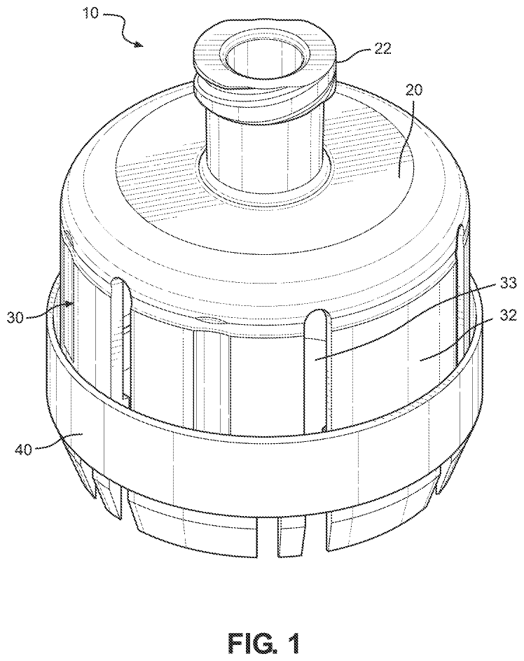

The present disclosure describes a new drug transfer device, such as a vial adapter, configured to mount onto a vial sealed by a plastic closure system. In particular, FIGS. 1-4 show such a vial adapter 10 that is operable to gain access to the contents of a drug vial sealed by a plastic closure system. Typical plastic closure systems include an elastomeric stopper and a plastic cap. The elastomeric stopper, such as a rubber stopper, fits within an aperture in a generally cylindrically shaped head portion of a conventional vial to seal the contents of the vial. The plastic cap fits over, and is secured to, the head portion of the vial, e.g., via a snap-fit connection, thus eliminating the need for a metal crimp ring. In some instances, the plastic cap can be generally cylindrical. One such example of a plastic closure system is the Daikyo Plascap®, which provides one step assembly to a conventional drug vial through an integrated stopper and plastic cap that helps ensure flexibility, allows for smaller batch sizes, and reduces risks associated with aluminum seals. The West LyoSeal® cap is another example of a plastic closure system that helps protect and maintain vacuum pressure within a vial, while simplifying the capping process. The LyoSeal® cap is made from medical grade polypropylene and allows lyophilization and crimping in one step, thus providing an instant seal. Some plastic closure systems can also include additional securement features, such as an annular locking recess provided on the plastic cap that can be utilized to enhance attachment of the vial adapter 10 thereto, as will be discussed in detail below.

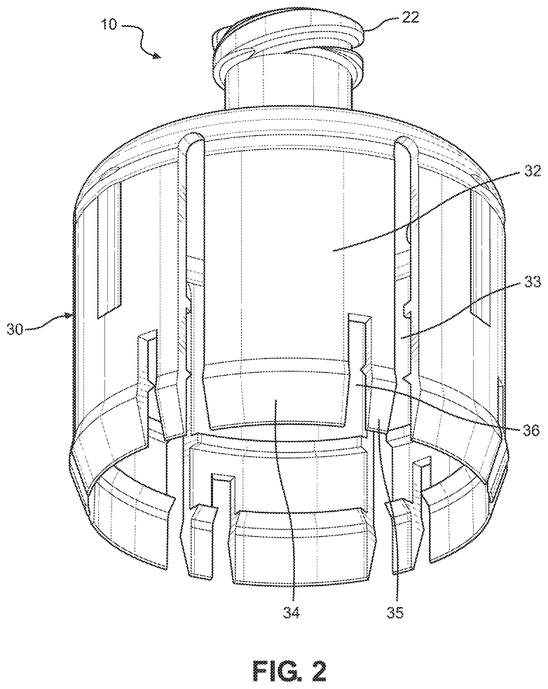

Referring to FIGS. 1 and 2, the vial adapter 10 of the present disclosure includes a top wall 20 and a connector 22 extending from the top wall in a first direction. In some implementations, the connector 22 can be a male Luer lock connector, while in other implementations, the connector 22 can be a female Luer lock connector. In still other implementations the connector 22 can be a connector other than a Luer lock such as another type of universal quick connection, or a custom or proprietary connection so that connection with the vial adapter 10 can be limited to other devices the share a complimentary custom or proprietary connection. 60

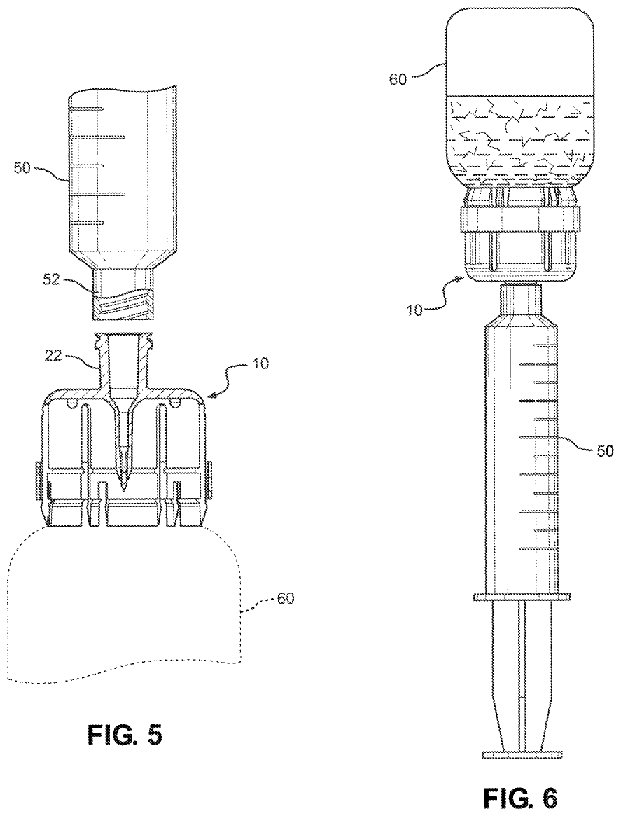

A skirt 30 can be connected to the top wall 20 and can extends in a second direction that is opposite from the first direction of the extending connector. The skirt 30 can be resiliently deformable and generally cylindrical shaped. The skirt 30 defines an opening that is sized and shaped to at least partially receive the plastic closure system attached to the vial. The skirt 30 is configured to releasably engage the plastic closure system. Accordingly, the skirt 30 is configured to connect to the plastic closure system so that the vial adapter 10 correspondingly interconnects with the vial, as shown in FIG. 5.

Turning back to FIGS. 1 and 2, the skirt 30 includes at least one flexible retention arm 32. According to some aspects, the skirt can include a plurality of flexible retention arms circumferentially spaced apart by respective slits 33. Each flexible retention arm 32 is elastically attached to the top wall 20. The slits 33 are thus disposed between adjacent flexible retention arms 32 to provide each flexible retention arm with an adequate degree of flexibility for fitting over the plastic closure system. More particularly, the at least one flexible retention arm 32 permits the skirt 30 to securely snap over the plastic cap attached to the head portion of the vial. Although the vial adapter 10 illustrated herein includes six flexible retention arms 32, more or less flexible retention arms can be provided depending on the desired flexibility of the skirt 30. In some aspects, the skirt of the vial adapter can be integrally formed of injection molded plastic, such as polypropylene or the like.

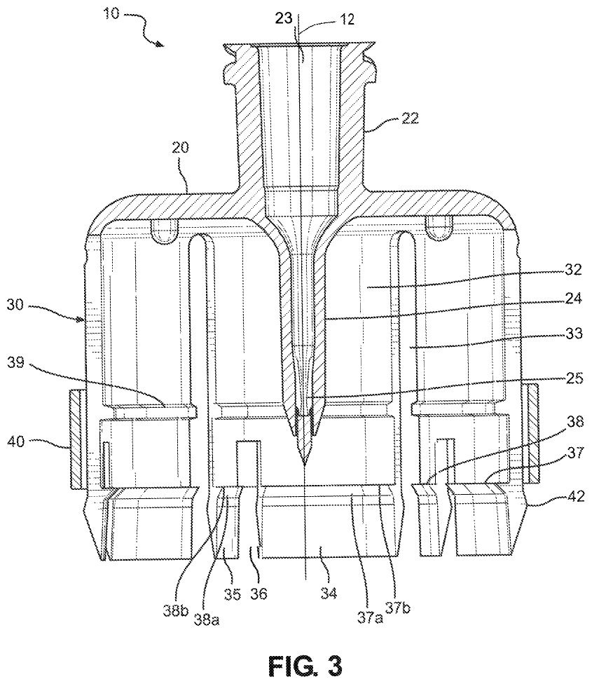

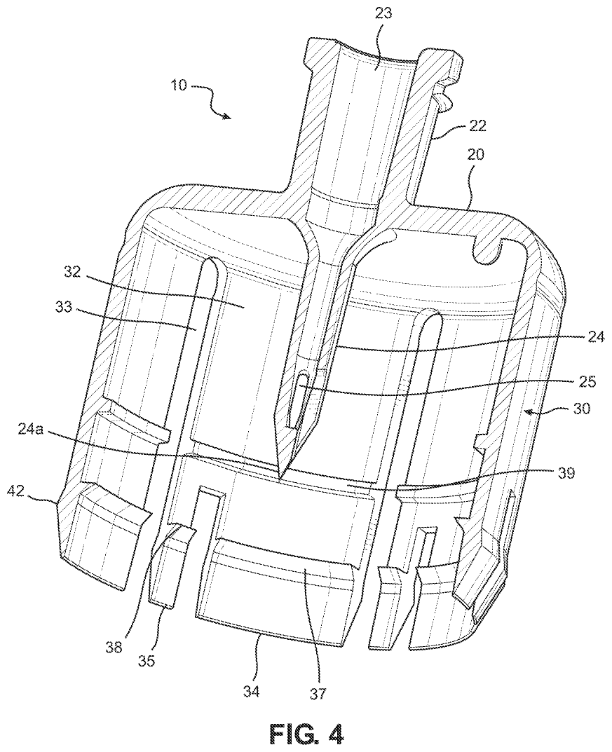

Referring to FIGS. 3 and 4, a piercing cannula 24, which can be hollow, extends from the top wall in the second direction along a longitudinal axis 12 of the vial adapter 10, which is opposite the first direction of the extending connector 22. The piercing cannula 24 protrudes into the skirt 30 that is configured to releasably secure to the plastic closure system attached to the vial. Moreover, a sharp distal tip 24a of the piercing cannula 24 includes a flow aperture 25 in fluid communication with an outlet 23 of the connector 22. Accordingly, when the vial adapter 10 is attached to the vial via the plastic closure system, the piercing cannula 24 pierces the elastomeric stopper, thus permitting fluid communication between the vial and the connector 22.

A distal region of each flexible retention arm 32 includes a first flexible finger 34 and a second flexible finger 35. The first and second flexible fingers 34, 35 are spaced apart by a cutout portion 36. In some aspects, the first flexible finger 34 can be larger than the second flexible finger 35, such that the stiffness of the first flexible finger is greater than the stiffness of the second flexible finger (or stated another way, the flexibility of the second flexible finger is greater than the flexibility of the first flexible finger). In other implementations, the first and second flexible fingers 34, 35 can be the same size, such that the stiffness of the first and second flexible fingers 34, 35 is the same (or stated another way, the flexibility of the first and second flexible fingers 34, 35 is the same). The first and second flexible fingers 34, 35 are configured to removably engage a bottom portion of the plastic closure system via a snap fit connection.

In embodiments, each first flexible finger 34 includes a respective inner surface having a first retention latch 37, such as a ridge or pawl, extending therefrom into the opening defined by the skirt 30. The first retention latch 37 has a leading face 37a that is slanted relative to the inner surface of the first flexible finger 34 to facilitate a sliding movement over an upper end of the plastic closure system. The first retention latch 37 further has a trailing face 37b that is substantially perpendicular relative to the inner surface of the first flexible finger 34 for securely gripping a bottom end of the plastic closure system. In embodiments, the first retention latch 37 can be formed integrally with the respective first flexible finger 34. Alternatively, the first retention latch 37 can be distinct from the respective first flexible finger 34 and can be made of the same or a different material from the respective first flexible finger 34.

Similarly, in embodiments each second flexible finger 35 includes a respective inner surface having a second retention latch 38, such as a ridge or pawl, extending therefrom. The second retention latch 38 has a leading face 38a that is slanted relative to the inner surface of the second flexible finger 35 to facilitate sliding over the upper end of the plastic closure system. The second retention latch 38 further has a trailing face 38b that is substantially perpendicular relative to the inner surface of the second flexible finger 35 for securely gripping the bottom end of the plastic closure system. In embodiments, the second retention latch 38 can be formed integrally with the respective second flexible finger 35. Alternatively, the second retention latch 38 can be distinct from the respective second flexible finger 35 and can be made of the same or a different material from the respective second flexible finger 35.

The first and second retention latches 37, 38, either taken separately or together, therefore provide a latch mechanism for engaging the vial adapter 10 to the plastic closure system attached to the vial.

In embodiments, only some of the first flexible fingers 34, including only one first flexible finger 34, can include the first retention latch 37 and other first flexible fingers 34 can be provided without the first retention latch 37. Similarly, in embodiments only some of the second flexible fingers 35, including only one second flexible finger 35, can include the second retention latch 38 and other second flexible fingers 35 can be provided without the second retention latch 38. Additionally or alternatively, at least one first retention latch 37 of a first flexible finger 34 can have a different dimension (e.g., can be smaller, larger, shaped different, etc.) than at least one other first retention latch 37 of another first flexible finger 34. Additionally or alternatively, at least one second retention latch 38 of a second flexible finger 35 can have a different dimension (e.g., can be smaller, larger, shaped different, etc.) than at least one other second retention latch 38 of another second flexible finger 35. Such configurations can permit both easier initial location of the vial adapter 10 over the plastic closure system and can act as an aid to keep the longitudinal axis 12 of the vial adapter 10 concentric with a longitudinal axis of the plastic closure system, which can reduce the risk damage and/or leaks that can result from non-concentric engagement between the vial adapter 10 and the plastic closure system.

Further, an intermediate region of one, each, or some of the flexible retention arms 32 can include a respective locking tongue 39 extending from an inner surface of the flexible retention arm and into the opening defined by the skirt 30. The locking tongue 39 can be positioned proximal to the first and second flexible fingers 34, 35. The locking tongue 39 can be operable to mate, via a snap fit connection, with a corresponding annular recess provided along a circumferential perimeter of the plastic cap of the plastic closure system. As such, the locking tongue 39 therefore provides a lock mechanism for further securing the vial adapter to the plastic closure system attached to the vial. In some implementations, the locking tongue 39 can be a ridge, dimple, rib, or ledge, among others. In embodiments, the locking tongue 39 can be formed integrally with the flexible retention arms 32. Alternatively, the locking tongue 39 can be distinct from the flexible retention arms 32 and can be made of the same or a different material from the flexible retention arms 32. Moreover, in some implementations, the annular recess formed in the plastic cap can include a groove, thread, slot, divot, or indentation, among others. In other implementations, at least one vertical channel can be formed on the cylindrical cap for guiding the at least one flexible retention arm.

In some implementations, the vial adapter 10 can include an elastomeric band 40. The elastomeric band 40 can be removably provided on an outer surface of the skirt 30. The elastomeric band 40 can operably compress the at least one flexible retention arm 32 of the skirt 30 inwardly in a uniform manner so as to ensure an adequate snap fit connection with the plastic closure system. The compressive force supplied by the elastomeric band 40 upon the at least one flexible retention arm 32 is furthermore maintained in order to prevent a user from inadvertently pulling the skirt off of the plastic cap, and thus preventing accidental detachment of the vial adapter from the plastic closure system. An lip 42 can be provided on the outer surface of the skirt in order to prevent the elastomeric band 40 from sliding off the skirt 30 during use. The lip 42 can be annular. For instance, each flexible retention arm 32 can include a distal region having an outer surface with the lip 42 protruding outwardly therefrom. According to some aspects, the lip 42 can be provided on the outer surface of one or both of the first and second flexible fingers 34, 35 in order to block the elastomeric band 40 from inadvertently sliding off the distal region of the skirt. In embodiments, the elastomeric band 40 can be a rubber ring, though other materials, material combinations including materials with different durometers and elasticities are possible. The elastomeric band 40 can be adapted for a number of different geometries to accommodate compressive forces desirable for a number of different applications. For example, a cross sectional geometry (e.g., height, thickness, etc.) can be adapted based to provide desirable compressive forces for particular applications.

When attaching the vial adapter 10 to a plastic closure system attached to a vial, a user first aligns the vial adapter to be approximately concentric with the plastic closure system, such that the piercing cannula 24 aligns with the elastomeric stopper of the vial. The first and second flexible fingers 34, 35 of each flexible retention arm 32 extend downwardly beyond the sharp distal tip 24a of the piercing cannula 24 such that the respective retention latches 37, 38 of each first and second flexible finger 34, 35 are operable to simultaneously contact the plastic closure system before the piercing cannula contacts the elastomeric stopper. This allows the at least one flexible retention arm 32 to guide the vial adapter into the approximately concentric alignment with the vial aperture as the user pushes the vial adapter over the plastic closure system, thus ensuring the sharp distal tip of the cannula is sufficiently aligned to puncture the elastomeric stopper.

For instance, initial depression of the vial adapter 10 towards the vial causes the at least one flexible retention arm 32, including the respective first and second flexible fingers 34, 35, to flex slightly outward as they travel along a peripheral surface of the plastic closure system, while the sharp distal tip 24a of the piercing cannula 24 approaches the elastomeric stopper of the vial. Continued depression of the vial adapter 10 towards the vial causes the at least one flexible retention arm 32 to slide over the peripheral surface of the plastic closure system until the respective first and second flexible fingers 34, 35 snap fit over a bottom edge of the plastic closure system, and the flow aperture 25 of the piercing cannula is positioned within the vial for permitting flow communication with the outlet 23 of the connector 22.

Additionally, continued depression of the vial adapter 10 towards the vial causes the at least one flexible retention arm 32 to slide over the peripheral surface of the plastic closure system until the respective the locking tongues 39 snap fit into a corresponding annular locking recess disposed along a periphery of the plastic cap of the plastic closure system for providing a lock mechanism to further securing the vial adapter to the plastic closure system attached to the vial. According to some aspects, the elastomeric band 40 provides an additional compressive force to the at least one flexible retention arm 32 when it flexes outwardly upon depression of the vial adapter over the plastic closure system. This compressive force exerted by the elastomeric band 40 helps urge the at least one flexible retention arm inwardly toward the plastic closure system so as to help ensure the respective retention latches and the locking tongues snap fit with the corresponding sections of the plastic closure system.

The vial adapter 10 is further configured to connect to another drug transfer device, such as a syringe 50 (e.g., a needless syringe), as shown in FIGS. 5 and 6. In particular, the connector 22 of the vial adapter 10 can be configured to threadably mate with a corresponding syringe connector 52. According to some aspects, the connector 22 of the vial adapter can be a male Luer connector and the syringe connector 52 can be a corresponding female Luer connector, though as discussed above other connection types are possible. Once the vial 60 is connected to the syringe 50 via the vial adapter 10, the syringe 50 can then be used in a conventional manner to withdraw the drugs 62 contained in the vial 60 into the syringe 50 so that they can be delivered to a patient.

In some implementations, the vial adapter 10 is configured to connect to another drug transfer device, such as a another vial adapter. For instance, a pair of vial adapters 10 can be used for transferring and mixing first and second substances contained within first and second vials to form a mixture that can be delivered to the patient. For instance, a first vial containing a powered or lyophilized substance can be connected to a second vial containing a diluent via a closed system transfer device comprising a first vial adapter and a second vial adapter. In such a closed system transfer device, each vial adapter is attachable to a respective plastic closure system connected to a corresponding vial. Moreover, the first and second vial adapters are generally identical to each other, as described above, except for their respective connectors. For instance, the connector of the first vial adapter can be a male Luer connector, and the connector of the second vial adapter can be a corresponding female Luer connector. Accordingly, the first vial adapter is configured to be threadably connected to the second vial adapter for fluidly connecting the corresponding first and second vials to each other.

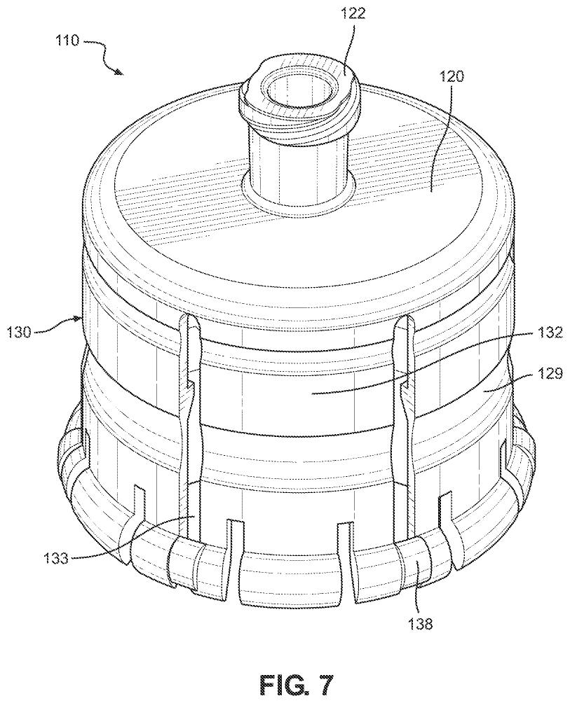

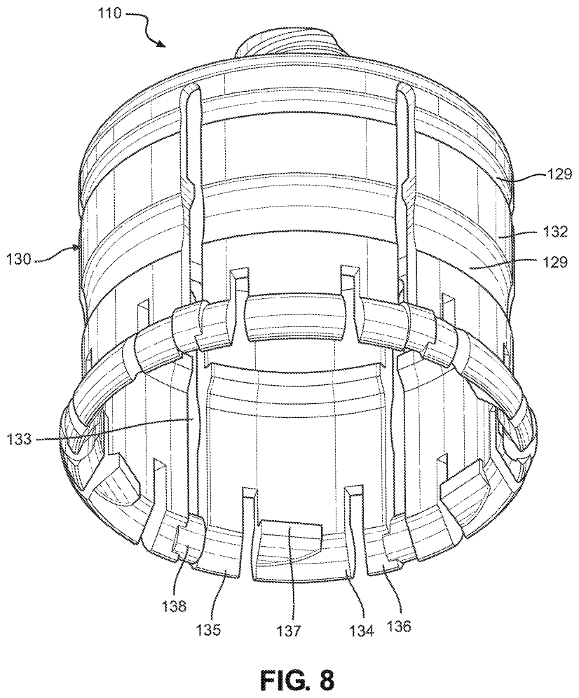

Turning next to FIGS. 7 and 8, another implementation of a vial adapter 110 for a plastic closure system is shown. The vial adapter 110 can include any of the features described above in reference to the vial adapter 10, and vice versa. For example, the vial adapter 110 can include a top wall 120 and a connector 122 extending from the top wall in a first direction. According to some aspects, the connector 122 can be a male Luer lock connector, while in other aspects, the connector 122 can be a female Luer lock connector. The connector 122 can take the form of any of the other connectors previously described in reference to the connector 22. A skirt 130 can be connected to the top wall 120 and can extend in a second direction that is opposite from the first direction of the extending connector 122. The skirt 130 can be resiliently deformable and can be generally cylindrical shaped. The skirt 130 defines an opening that is sized and shaped to at least partially receive and releasably engage a plastic closure system attached to a vial. Accordingly, the skirt 130 is configured to connect to the plastic closure system so that the vial adapter 110 correspondingly interconnects with the vial.

The skirt 130 includes at least one flexible retention arm. According to some aspects, the skirt can include a plurality of flexible retention arms 132 circumferentially spaced apart by respective slits 133. Each flexible retention arm 132 is elastically attached to the top wall 120. The slits 133 are disposed between adjacent flexible retention arms 132 to provide each flexible retention arm with a degree of flexibility for fitting over the plastic closure system. As such, the at least one flexible retention arm 132 permits the skirt 130 to securely snap over the plastic cap attached to the head portion of the vial. Although the vial adapter 110 illustrated herein includes six flexible retention arms 132, more or less flexible retention arms can be provided depending on the desired flexibility of the skirt 130. A thickness of the skirt 130 can be varied along the longitudinal axis 12 of the vial adapter 10. For example, the skirt 130 one or more annular grooves or depressions 129 can provide thin wall sections of each flexible retention arm 132 to allow for controlled, predictable flexing of each flexible retention arm during installation of the skirt on the plastic closure system. In some aspects, the annular grooves or depressions 129 can also provide a seat for an elastomeric band surrounding the skirt. In embodiments, regions of the skirt 130 can have a cross-sectional thickness that is greater than a cross-sectional thickness of other regions of the skirt 130. According to such configurations, the comparatively thicker regions could define an indexing feature that could help lock the vial adapter 10 in relation to the plastic closure system and can prevent or limit rotation of the vial adapter 10 with respect to the plastic closure system.

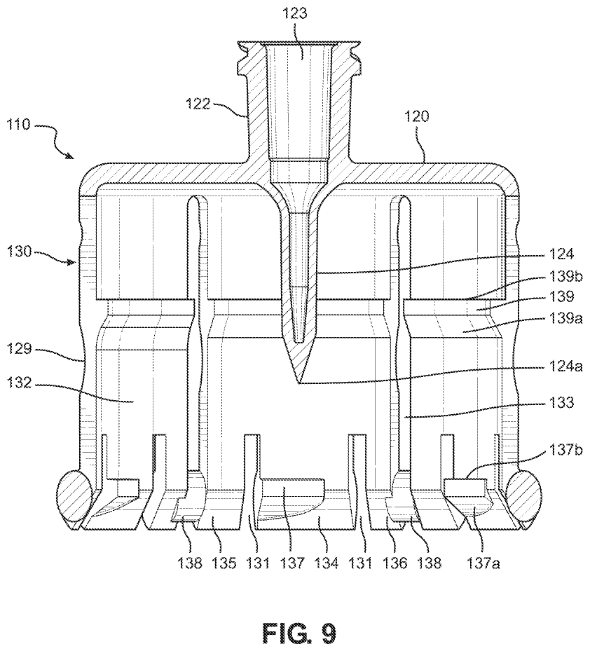

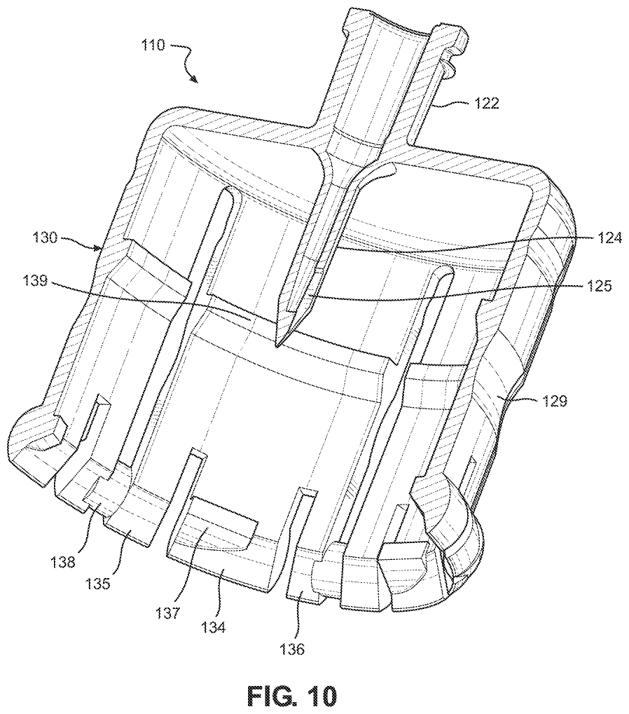

As shown in FIGS. 9 and 10, a piercing cannula 124 extends from the top wall 120 in the second direction, which is opposite the first direction of the extending connector 122. The piercing cannula 124 protrudes into the skirt 130, and a sharp distal tip 124a of the piercing cannula 124 includes a flow aperture 125 in fluid communication with an outlet 123 of the connector 122. When the vial adapter 10 is attached to the vial via the plastic closure system, the piercing cannula 124 pierces the elastomeric stopper, thus permitting fluid communication between the vial and the outlet 123 of the connector 122.

A distal region of each flexible retention arm 132 includes a first flexible finger 134, a second flexible finger 135, and a third flexible finger 136. The first flexible finger 134 is disposed between the second and third flexible fingers 135, 136 and respectively spaced apart therefrom by a cutout portion 131. In some aspects, the first flexible finger 134 can be larger than the second and third flexible fingers 135, 136 such that the stiffness of the first flexible finger is greater than the stiffness of the other flexible fingers. In other words, the flexibility of the second and third flexible fingers is greater than the flexibility of the first flexible finger. In other implementations, the first, second, and third flexible fingers can be the same size, such that the stiffness of each flexible finger is the same (or stated another way, the flexibility of each flexible finger is the same).

The first flexible finger 134 of each flexible retention arm 132 is configured to removably engage a bottom portion of the plastic closure system via a snap fit connection. In particular, each first flexible finger 134 includes a respective inner surface having a retention latch 137, such as a ridge or pawl, extending therefrom into the opening defined by the skirt 130. The retention latch 137 has a leading face 137a that is slanted relative to the inner surface of the first flexible finger 134 to facilitate a sliding movement over an upper end of the plastic closure system. The retention latch 137 further has a trailing face 137b that is substantially perpendicular relative to the inner surface of the first flexible finger 134 for securely gripping a bottom end of the plastic closure system. The retention latch 137 therefore provides a latch mechanism for engaging the vial adapter to the plastic closure system attached to the vial.

A connection bridge 138 is disposed within each slit 133 and interconnects adjacent flexible retention arms 132. This interconnection provides local rigidity to each flexible retention arm 132, and thus can replace the need for the separate elastomeric band discussed above. The interconnection provided by the connection bridge 138 between adjacent flexible retention arms 132 also helps ensure a concentric attachment of the vial adapter to the plastic closure system during installation. According to some aspects, each connection bridge 138 interconnects the second and third flexible fingers 135, 136 of directly adjacent flexible retention arms 132. The connection bridge 138 can be integrally formed along with the skirt of the vial adapter by injection molded plastic, such as polypropylene or the like.

Further, an intermediate region of each flexible retention arm 132 includes a respective locking tongue 139 extending from an inner surface of the flexible retention arm and into the opening defined by the skirt 130. The locking tongue 139 is positioned proximal to the first, second, and third flexible fingers. The locking tongue 139 is operable to mate, via a snap fit connection, with a corresponding annular recess provided along an outer periphery of the plastic cap of the plastic closure system. As such, the locking tongue 139 therefore provides a lock mechanism for further securing the vial adapter to the plastic closure system attached to the vial. Moreover, each locking tongue 139 includes a leading face 139a that is slanted relative to the inner surface of the flexible retention arm 132 to facilitate sliding over the upper end of the plastic closure system during installation. The locking tongue 139 further has a trailing face 139b that is substantially perpendicular relative to the inner surface of the flexible retention arm 132 for securely gripping the bottom end of the plastic closure system. In some implementations, the locking tongue can be a ridge, dimple, rib, or ledge, among others.

When attaching the vial adapter 110 to a plastic closure system attached to a vial, a user first aligns the vial adapter to be approximately concentric with the plastic closure system, such that the piercing cannula 124 aligns with the elastomeric stopper of the vial. The flexible fingers 134, 135, 136 of each flexible retention arm 132 extend downwardly beyond the sharp distal tip 124a of the piercing cannula 124 such that the respective retention latches 137 of each flexible retention arm 132 are operable to contact the plastic closure system before the piercing cannula contacts the elastomeric stopper. This allows the at least one flexible retention arm 132 to guide the vial adapter into the approximately concentric alignment with the vial aperture as the user pushes the vial adapter over the plastic closure system, thus ensuring the sharp distal tip of the cannula is sufficiently aligned to puncture the elastomeric stopper.

An initial depression of the vial adapter 110 towards the vial causes the at least one flexible retention arm 132, including the respective first, second, and third flexible fingers to flex slightly outward as they travel along a peripheral surface of the plastic closure system, while the sharp distal tip 124a of the piercing cannula 124 approaches the elastomeric stopper of the vial. Continued depression of the vial adapter 110 towards the vial causes the at least one flexible retention arm 132 to slide over the peripheral surface of the plastic closure system until the respective flexible fingers snap fit over a bottom edge of the plastic closure system, and the flow aperture 125 of the piercing cannula is positioned within the vial for permitting flow communication with the outlet 123 of the connector 122. Continued depression of the vial adapter 110 towards the vial causes the at least one flexible retention arm 132 to slide over the peripheral surface of the plastic closure system until the respective the locking tongues 139 snap fit into a corresponding annular locking recess disposed along a periphery of the plastic cap of the plastic closure system for providing a lock mechanism to further securing the vial adapter to the plastic closure system attached to the vial. According to some aspects, the connection bridge 138 provides additional rigidity to the distal end of each flexible retention arm, and more particularly to the second and third flexible fingers, to help ensure the retention latches and the locking tongues snap fit with the corresponding sections of the plastic closure system.

While certain implementations of a vial adapter for a plastic closure system have been described in terms of what may be considered to be specific aspects, the present disclosure is not limited to the disclosed aspects. Additional modifications and improvements to the aforementioned vial adapter may be apparent to those skilled in the art. Moreover, the many features and advantages of the disclosure are apparent from the detailed specification, and thus, it is intended by the appended claims to cover all such features and advantages of the present disclosure which fall within the spirit and scope of the disclosure.

1. A vial adapter configured to mount to a vial that is sealed by a closure system having an elastomeric stopper and a cap, the vial adapter comprising:
a top wall configured to cover a top portion of the closure system when the vial adapter is mounted to the vial;
a connector extending from the top wall in a first direction, the connector configured to connect to a drug transfer device;
a cannula extending from the top wall in a second direction, the cannula including a sharp distal tip operable to pierce the elastomeric stopper of the closure system and to provide for fluid communication between the vial adapter and the vial when the vial adapter is mounted to the vial; and
a skirt extending from the top wall and surrounding the cannula, the skirt defining an opening configured to at least partially receive the closure system, the skirt including at least one flexible retention arm having a retention latch configured to snap fit to an underside portion of the cap of the closure system when the vial adapter is mounted to the vial, wherein the cannula has a length from the top wall such that the sharp distal tip of the cannula is located proximal to the retention latch.

2. The vial adapter of claim 1, wherein the flexible retention arm further comprises a locking tongue protruding into the opening defined by the skirt, the locking tongue configured to correspondingly snap fit into an annular recess formed along a circumferential perimeter of the cap of the closure system when the retention latch snap fits to the underside portion of the cap.

3. The vial adapter of claim 1, wherein the retention latch is a pawl having a leading face configured to facilitate attachment of the skirt over the top portion of the closure system, and a trailing face configured to lock the skirt to the underside portion of the closure system.

4. The vial adapter of claim 1, further comprising an elastomeric band surrounding the skirt and operable to resist the flexible retention arm from deflecting away from the cannula.

5. The vial adapter of claim 4, wherein the elastomeric band is a rubber ring.

6. The vial adapter according to of claim 4, wherein an outer surface of the skirt includes a lip protruding away from the cannula, and the lip is configured to prevent the elastomeric band from sliding off the skirt when the flexible retention arm is not deflected.

7. The vial adapter of claim 1, wherein the skirt includes a plurality of flexible retention arms.

8. The vial adapter of claim 7, wherein the skirt further comprises at least one slit that separates adjacent flexible retention arms.

9. The vial adapter of claim 8, wherein the skirt further comprises at least one connection bridge disposed within a corresponding at least one slit and interconnecting adjacent flexible retention arms.

10. The vial adapter of claim 1, wherein the skirt further comprises an outer surface having an annular groove configured to provide controlled flexing of each flexible retention arm.

11. The vial adapter of claim 10, wherein the annular groove forms a corresponding section of decreased thickness in each flexible retention arm.

12. The vial adapter of claim 1, wherein each flexible retention arm further includes a first flexible finger and a second flexible finger.

13. The vial adapter of claim 12, wherein the first and second flexible fingers of each flexible retention arm are separated by a cutout portion.

14. The vial adapter of claim 1, wherein the cannula extends along a longitudinal axis of the vial adapter perpendicular to the top wall.

15. The vial adapter of claim 1, wherein the first direction of the connector extending from the top wall is opposite from the second direction of the cannula extending from the top wall.

16. The vial adapter of claim 1, wherein the connector extends along a longitudinal axis of the vial adapter substantially perpendicular to the top wall.

17. The vial adapter of claim 1, wherein the connector is a Luer connector.

18. A method of using a vial adapter having a connector, a cannula, and a skirt including at least one flexible retention arm having a retention latch, to access contents of a vial sealed by a closure system having an elastomeric stopper and a cap, the method comprising:
aligning the vial adapter to be substantially concentric with the closure system;
pushing the vial adapter over the closure system such that the at least one flexible retention arm deflects away from a longitudinal axis of the vial adapter as the cap is received within an opening of the skirt and until the retention latch snap fits to an underside portion of the cap; and
connecting a drug transfer device to the connector of the vial adapter to establish fluid communication between the vial and the drug transfer device.

19. The method of claim 18, wherein a sharp distal tip of the cannula pierces the elastomeric stopper of the closure system after the at least one flexible retention arm is deflected away from the longitudinal axis of the vial adapter and before the retention latch snap fits to the underside portion of the cap of the closure system.

20. The method of claim 18, wherein the retention latch is a pawl having a leading face configured to facilitate attachment of the skirt over a top portion of the closure system, and a trailing face configured to lock the skirt to the underside portion of the closure system.
